(19) United States
(12) Patent Application Publication
(10) Pub. No.: US 2007/0035777 A1
(43) Pub. Date: Feb. 15, 2007

(54) Portable bottomless laser engraver

(76) Inventor: Michael J. Kintner, Olean, NY (US)

Correspondence Address: LITMAN LAW OFFICES, LTD, PO BOX 15035, CRYSTAL CITY STATION, ARLINGTON, VA, 22215, US

(21) Appl. No.: 11/201,184

(22) Filed: Aug. 11, 2005

(51) Int. Cl. B41C 1/04

(52) U.S. Cl. 358/3.29; 358/3.32

(57) ABSTRACT

A portable bottomless laser engraver includes a lower housing with a bottom defining an area and an aperture defining an area through the bottom substantially the same as the area of the bottom. An upper housing is interconnected to the lower housing. A laser assembly with a laser is mounted in the upper housing. The laser engraver is configured to etch a design/pattern/lettering in a workpiece having an area not restricted by the area defined by the aperture in the bottom of the lower housing. Handles are attached to the lower housing and removable wheels can removably attached to the handles. Adjustable vents are mounted in the lower housing. A seal is placed on the bottom of the lower housing, and a top is pivotally attached to the lower housing. A control panel is attached to the upper housing that includes a plurality of input/output interfaces and a display.

### BACKGROUND OF THE INVENTION

1. Field of the Invention

The present invention relates generally to engraving machines that carve, cut or etch designs, letters, etc. into a workpiece and, more particularly, to a portable bottomless laser engraver.

2. Description of the Related Art

Engraving machines are known which include workpiece holding areas where workpieces of a predetermined size or smaller are placed. Such engraving machines are then provided with programmings that include speed settings and design patterns for particular workpiece materials. These engraving machines are inherently limited in their engraving capabilities because they are unable to engrave designs and/or other images on workpieces that are larger than their workpiece holding areas. Therefore, a need exists for a portable bottomless laser engraver.

### SUMMARY OF THE INVENTION

The present invention is a portable bottomless laser engraver. The portable bottomless laser engraver includes a lower housing with a bottom defining an area and an aperture defining an area through the bottom substantially the same as the area of the bottom. An upper housing is interconnected to the lower housing. A laser assembly is mounted in the upper housing. The laser assembly has a laser. The bottomless laser engraver is configured to etch a design/pattern/lettering in a workpiece having an area that is not restricted by the area defined by the aperture in the bottom of the lower housing.

The lower housing is made from durable material, such as metal, plastic, composites, or combinations thereof. A plurality of handles is attached to the lower housing. A plurality of removable wheels is interconnected by a mounting that is removably attachable to the plurality of handles. A plurality of adjustable vents is mounted in the lower housing. A seal is placed on the bottom of the lower housing. A top is pivotally attached to the lower housing. The top can be transparent, translucent, or combinations thereof. A seal is attached to edges of the top. A control panel is attached to the upper housing. The control panel includes a plurality of input/output interfaces and a display.

The bottomless laser engraver has a base frame, guide rails/strips held within holders which are mounted on the base frame, a slide rail with ends movably attached to the guide rails/strips, light beam guiding units mounted on the base frame, a cutter seat movably mounted on the guide rail by an attachment, and a sensor attached to the cutter seat. Threaded elements are threaded through washers and corners of the base frame. The threaded elements each have a foot at one end and a roller at the opposite end. A belt passes around the rollers. The laser engraver also includes a drive roller and a drive motor.

An engraving method according to the invention carries out steps including providing a bottomless laser engraver, providing a workpiece having a predetermined size, inputting parameter data regarding an engraving operation into the bottomless laser engraver, and moving the bottomless laser engraver to the workpiece. The engraving method also carries out steps including selecting plural reference coordinates on the workpiece, and moving the bottomless laser engraver to each selected reference coordinate on the workpiece. The engraving method also carries out steps including associating reference coordinate with the bottomless laser engraver, moving the bottomless laser engraver to each reference coordinate, activating the laser engraver to effect an engraving operation for an area of the workpiece associated with that particular reference coordinate, recalling cutting seat positioning parameters for engraving a design portion corresponding to the area of the workpiece associated with that particular reference coordinate, and adjusting a height and position of the cutting seat to carry out the corresponding engraving operation for the area of the workpiece associated with that particular reference coordinate. The moving, activating, recalling and adjusting steps are repeated until the etching operation is complete.

### BRIEF DESCRIPTION OF THE DRAWINGS

FIG. 1 is a front perspective view of a portable bottomless laser engraver according to the present invention that is positioned over a portion of a workpiece.

FIG. 2 is a front perspective view of the portable bottomless laser engraver shown in FIG. 1.

FIG. 3 is a front perspective view of an arrangement of some components mounted within the portable bottomless laser engraver shown in FIG. 1.

FIG. 4 is a bottom perspective view of the arrangement shown in FIG. 3.

FIG. 5 is a rear perspective view of the portable bottomless laser engraver shown in FIG. 1.

FIG. 6 is a block diagram of circuitry for the portable bottomless laser engraver shown in FIG. 1.

Similar reference characters denote corresponding features consistently throughout the attached drawings.

### DETAILED DESCRIPTION OF THE PREFERRED EMBODIMENTS

The present invention is a portable bottomless laser engraver. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

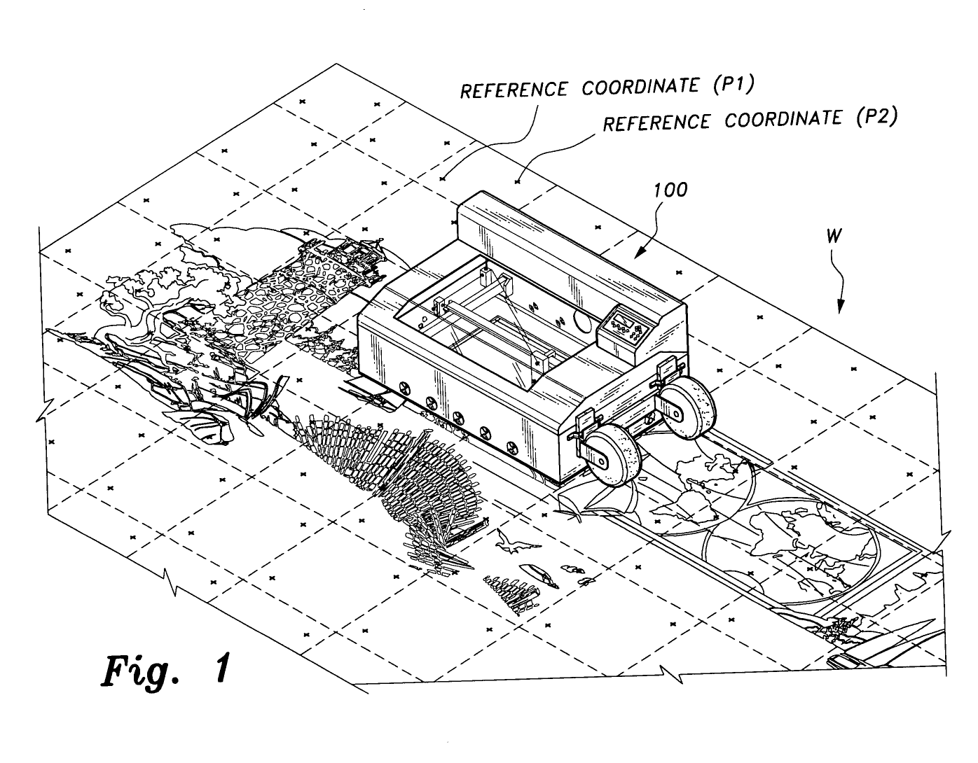

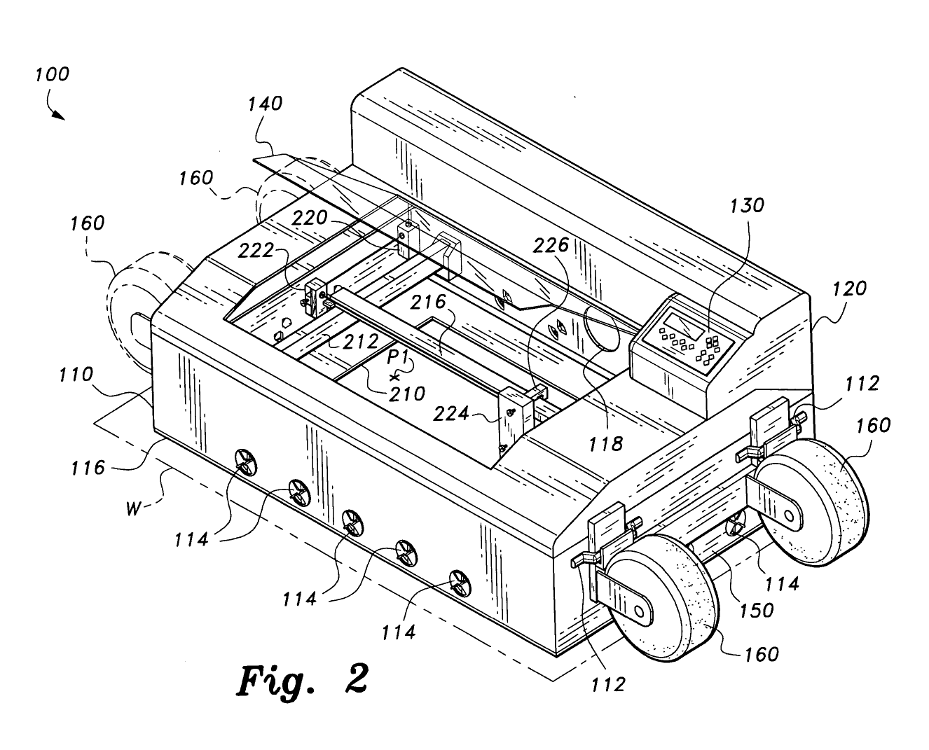

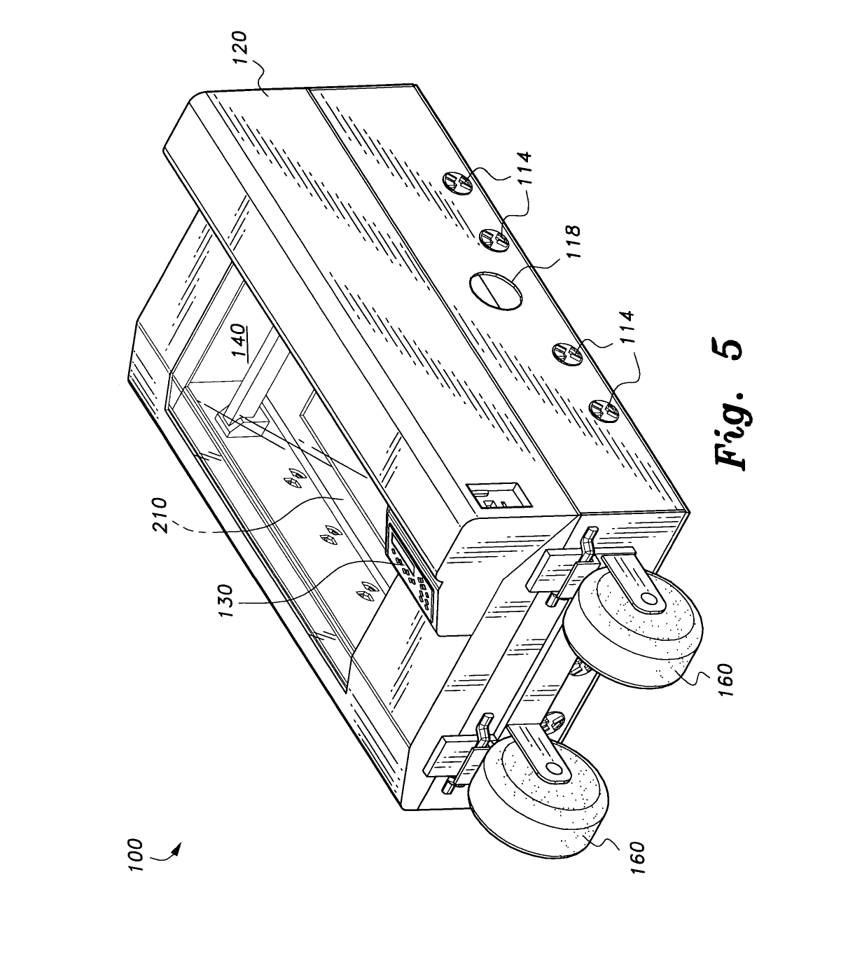

Referring to the drawings, FIGS. 1-5 show a portable bottomless laser engraver 100 according to the invention. The portable bottomless laser engraver 100 is positioned over a portion of a workpiece W in FIG. 1. The workpiece W is illustrated as a floor but can be configured in the form of any type of workpiece, such as a wall, a door, a table, a walkway, a piece of furniture, etc. The workpiece W can be any desired type of material, such as wood, metal, leather, plastic, rubber, composites, combinations thereof, etc. The workpiece W can also be positioned in any desired orientation, e.g., vertical, horizontal, angularly inclined, etc. A partially completed design of a seascape with a world atlas on the horizon has been engraved into the workpiece W. The workpiece W is shown with a grid pattern illustrating workpiece areas that each include reference coordinates P1 and P2. The grid pattern and reference coordinates P1 and P2 are predetermined by the user to properly reference the laser engraver 100 when the laser engraver 100 is positioned over a particular workpiece area. The grid pattern and reference coordinates P1 and P2 are only shown to demonstrate their utility and are not actual markings on the workpiece W.

The laser engraver 100 provides the ability to engrave workpieces of any size. Workpieces of a predetermined size that is restricted by the workpiece holding area of conventional laser engravers are normally placed in the workpiece holding area of conventional laser engravers. The laser engraver 100 allows users to engrave large designs over an unlimited area, and the laser engraver 100 can be configured in a variety of shapes other than the illustrated shape. More particularly, the laser engraver 100 allows users to engrave designs on a workpiece having an area that is not restricted by the area defined by the aperture in the bottom of the lower housing 110. Conventional or otherwise non-bottomless laser engravers can also be retrofitted or modified to effect or carry out the laser engraving processes, methods and/or other teachings contained herein.

The laser engraver 100 includes a lower housing 110 and an upper housing 120. The lower and upper housings 110 and 120 are preferably made from durable material such as metal, plastic, composites, combinations thereof, etc. The lower housing 110 can be configured in a generally rectangular form with two ends, two sides, a top and a bottom. However, the lower housing 110 can be configured in any desired shape. An aperture is defined through a substantial area of the bottom of the laser engraver 100, such that the laser engraver 100 is referred to throughout this disclosure as a bottomless laser engraver 100. More particularly, the lower housing 110 has a bottom defining an area and an aperture defining an area through the bottom substantially the same as the area of the bottom. Configuring the laser engraver 100 as a bottomless laser engraver provides significant advantages over typical closed engravers. A plurality of handles 112 are attached to the ends of the lower housing 120 to enable a user to lift the ends. A plurality of adjustable vents 114 are mounted in the ends and sides of the lower housing 120. The vents can be easily rotated to accommodate greater air flow through the laser engraver 100.

A seal 116 can be placed on the bottom of the lower housing 110 to enable the laser engraver 100 to be sealed to the workpiece W, thereby enhancing the ability to provide good airflow through the engraver 100 to enable fumes and workpiece particles to be sucked out of the engraver during engraving operations. The seal 116 can be a rubber seal, a solid rubber seal with adjustable vented holes located in the lower housing 110 that can be opened or closed, or the like. An aperture 118 is defined through the rear side of the engraver 100, and similar apertures can be defined through the other side and each end to provide exhaust vent(s) for the engraver 100. Compressor(s) and/or vacuum(s) can be interconnected to the exhaust vent(s) via hosing(s) or tubing(s) to effect exhaust operations for the engraver 100. A plurality of wheels 160 interconnected by a mounting 150 can be removably attached or clipped to the handles 112 at either end of the laser engraver 100. The wheels 160 can be made of inflatable or non-inflatable material, such as rubber or the like, to enable a user to temporarily interconnect them at either end of the laser engraver 100. The user can then use the handles 112 on the opposite end of the engraver 100 to lift that particular end, and readily move the laser engraver 100 to another location.

A transparent and/or translucent top 140 made of material such as glass, plastic or the like, is pivotally connected to the top of the lower housing 110. A seal, such as rubber or the like, can be attached to the edges of the top 140 to inhibit the escape of any engraving fumes and/or workpiece debris that may result during engraving operations. Such a seal enhances the removal of such fumes and/or workpiece debris from the engraver 100 via exhaust operations. The top 140 enables the user to view the engraving operation and readily access components within the engraver 100 if desired or in the event of an emergency or problem situations regarding operation of the engraver 100.

An elongated laser assembly is mounted in the upper housing 120 of the engraver. The elongated laser assembly has a laser contained therein. The laser can be any desired laser, and can have a desired power output. For example, a laser assembly can be chosen with a laser having a power output of between about ten to about one hundred watts. A control panel 130 is mounted on the upper housing 120. The control panel 130 includes a plurality of input/output interfaces in the form of buttons and/or keys. The control panel 130 also includes a display, such as a liquid crystal display (LCD) or the like. The control panel may be entirely in the form of an LCD display with the input/output interfaces being configured in the form of touch sensitive icons or the like.

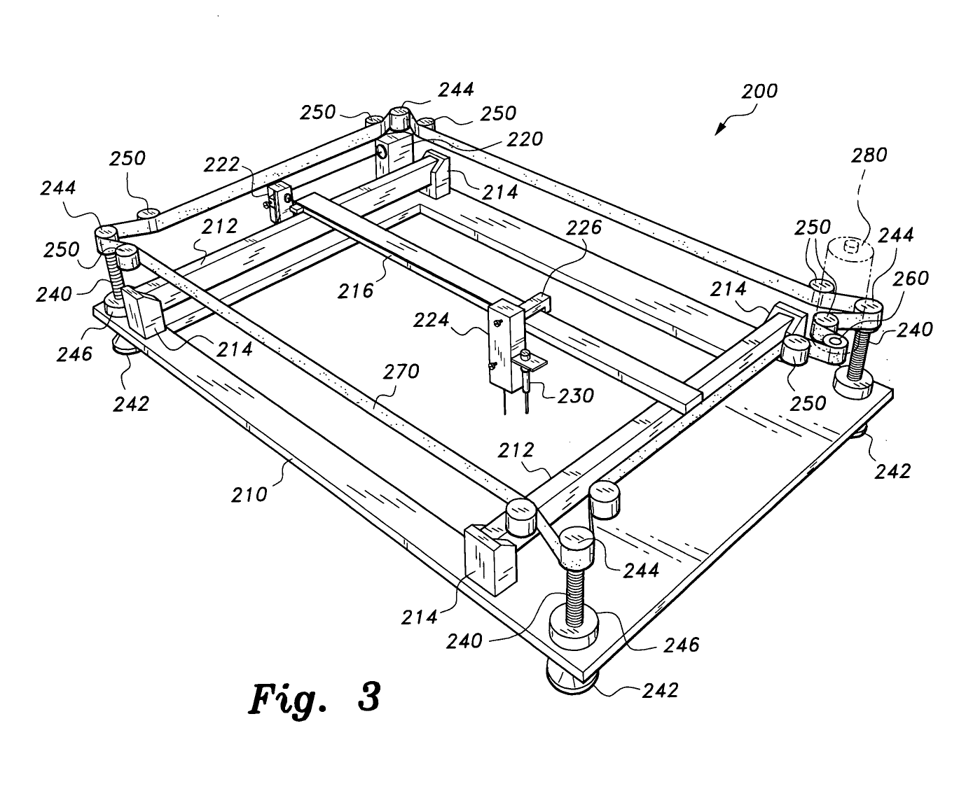

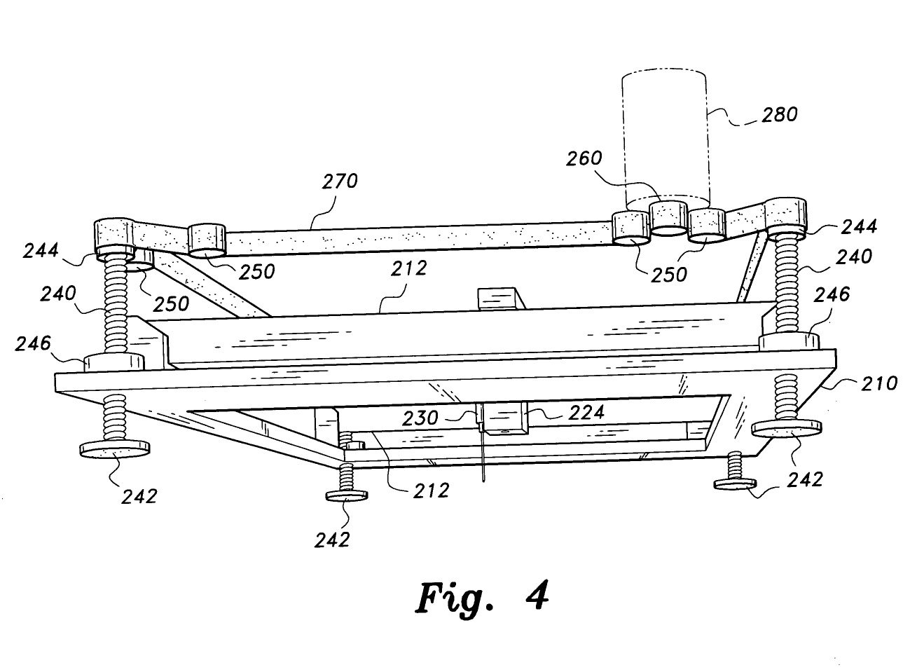

FIGS. 3 and 4 show an arrangement 200 of some of the internal components mounted within the portable bottomless laser engraver 100. The arrangement 200 includes a base frame 210. Guide rails or strips 212 are held within holders 214 which are mounted on the base frame 210. Ends of a slide rail 216 are movably attached to the guide rails/strips 212. Light beam guiding units 220 and 222 are mounted on the base frame 210. A cutter seat 224 is movably mounted on the guide rail 216 by attachment 226. A sensor 230 is attached to the cutter seat to sense the distance from the cutter to the workpiece.

Threaded elements 240 are threaded through washers 246 and corners of the base frame 210. The threaded elements 240 have feet at one end and a roller 244 at the other end. A belt 270 passes around the rollers 244 and other guide rollers 250, as well as a drive roller 260. A drive motor 280 drives the drive roller 260 and is contained within the upper housing 120 underneath the display 130.

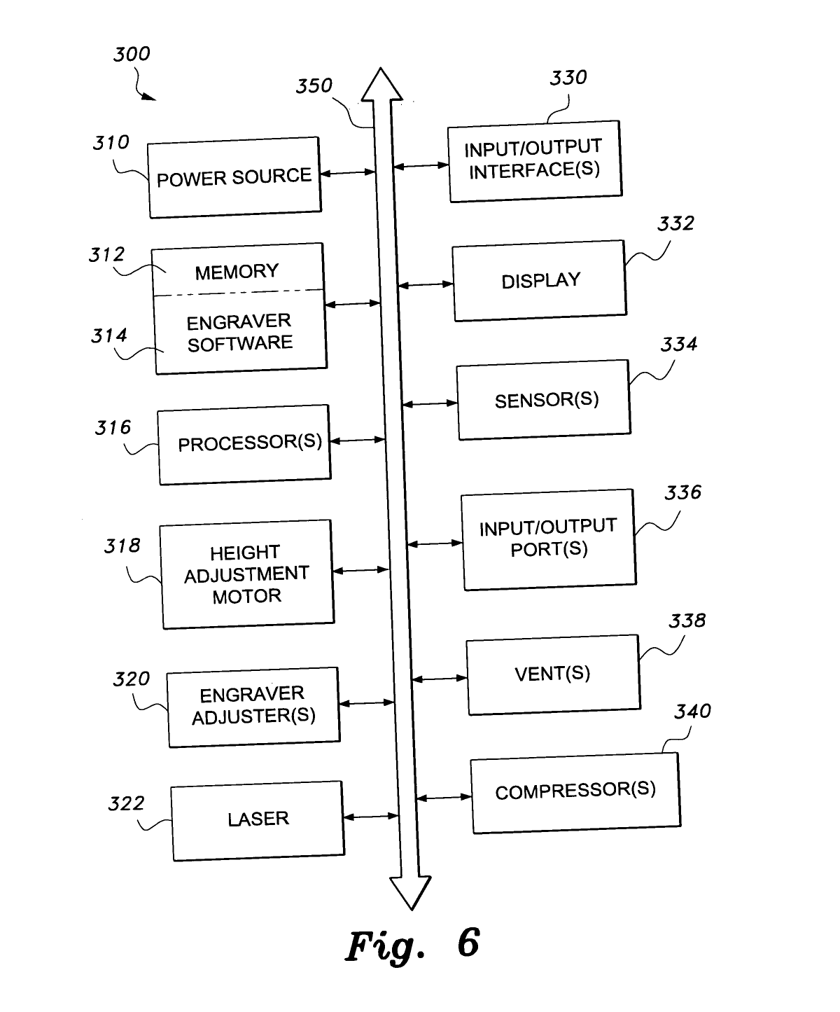

A block diagram of circuitry 300 contained within the portable bottomless laser engraver 100 is shown in FIG. 6. The circuitry 300 includes an internal or external power source 310, a memory 312 which carries engraver software 314 executable by one or more processors 316, a height adjustment motor 318, one or more engraver adjustors 320, a laser 322, one or more input/output interfaces 330, a display 332, one or more sensors 334, one or more input/output ports 336, and one or more vents 338. One or more compressors 340 can be internally or externally connected to the circuitry 300. A communication bus 350 communicatively interconnects these components.

The following briefly outlines an operation process of the portable bottomless laser engraver 100. A user initially determines and/or selects a particular design, pattern, lettering, etc., for engraving on a workpiece W. The workpiece W can have any desired size and can be configured out of any desired material. Once the particular design and workpiece size has been selected, data parameters corresponding to the particular design and workpiece size, as well as other engraving setting parameters are provided to the memory 312 of the circuitry 300. Engraving setting parameters can include a variety of items such as speed, intensity, material, etching depth, or any other desired engraving parameter. These parameters can be initially entered into associated data files at a remote computer. Such data files can be transferred to the engraver circuitry 300 wirelessly or non-wirelessly through use of a transceiver, memory sticks, floppy discs, data connection ports, or through the use of any other convenient data transfer device.

The portable bottomless laser engraver 100 is then moved to the workpiece W through use of removable wheels 160 or by other moving devices. Once the laser engraver 100 is moved to the workpiece W, the user can select desirable reference coordinates for various work areas within the workpiece W. The user can then move the laser engraver 100 so that each selected reference coordinate P1 and P2 can be read and set into the engraver 100 through the use of a reference laser sensor or other referencing device. When all reference coordinates P1 and P2 are set into the engraver 100, the engraver 100 is moved near each reference coordinate P1 and P2 associated with a particular workpiece area of the workpiece W to be engraved. The engraver 100 is zeroed to the reference coordinates P1 and P2 associated with the particular workpiece area. The engraver 100 can then be activated to effect an engraving operation for the workpiece area of the workpiece W associated with those reference coordinates P1 and P2.

The memory 312 of the engraver circuitry 300 can recall the cutting seat positioning parameters for engraving the design portion that corresponds to the workpiece area of the workpiece W associated with those reference coordinates P1 and P2. The height adjustment motor 316 and the engraver adjustor 318 then operate to adjust the height and position of the cutting seat 224 to carry out the corresponding engraving operation for the workpiece area of the workpiece W associated with those reference coordinates P1 and P2.

Once an engraving operation has been completed for one particular area, the portable bottomless laser engraver 100 can then be moved to any other workpiece area of the workpiece W to effect an engraving operation. Similar engraving operations can be effected to other workpiece areas of the workpiece W until the entire engraving design, pattern, etc. has been engraved into the workpiece W.

The portable bottomless laser engraver 100 enables users to conveniently and easily engrave their favorite patterns, graphics, artworks, etc. into walls, floors, doors, furniture, ceilings, vehicles, boats, planes, other vehicles, etc. For example, hardwood floors and/or colored exotic wood inlays can be easily engraved with the engraver 100. Any desired unique pattern and/or design can be programmed into the engraver to enable a user to engrave a desired workpiece. The engraver 100 can be licensed and/or sold to users, distributors, franchisers, etc., who can select from amongst hundreds even thousands of types of patterns/designs that can be engraved into a workpiece. The engraver 100 takes such patterns/designs from any sizes of inches to several or hundred feet in length and width and can be custom inlayed to favorite exotic hardwoods or just plain engraved into the workpiece.

Just imagine beautiful rosewood, ebony and many other types of wood inlayed into a hardwood floors at a fraction of the cost of normal inlays. The engraver 100 precludes the need to take apart a hardwood floor because the engraver can laser away the etched area and burn in any type of design/pattern into the hardwood floor. Patterns such as grapes, maples leaves, with exotic wood inlays can be engraved with the engraver 100 at a cost of only a fraction of the cost of actual wood inlays the old fashion way.

Residence/office entrances can be engraved to look like autumn leaves scattered on the floor or lobsters and sea shells inlayed with ebony, walnut, rosewood and much more. Users can choose from thousands of different patterns/designs that will just overwhelm guests as they enter homes, boats, motorhomes, etc. Other patterns can be engraved into cabinet doors, entrance doors, windows, or anything of any size.

In summary, the portable bottomless laser engraver includes a lower housing with a bottom defining an area and an aperture defining an area through the bottom that is nearly the same as the area of the bottom. An upper housing is interconnected to the lower housing. A laser assembly is mounted in the upper housing. The laser assembly has a laser. The bottomless laser engraver is configured to etch a design/pattern/lettering in a workpiece having an area that is not restricted by the area defined by the aperture in the bottom of the lower housing.

The lower housing is made from durable material, such as metal, plastic, composites, or combinations thereof. A plurality of handles is attached to the lower housing. A plurality of removable wheels is interconnected by a mounting that is removably attachable to the plurality of handles. A plurality of adjustable vents is mounted in the lower housing. A seal is placed on the bottom of the lower housing. A top is pivotally attached to the lower housing. The top can be transparent, translucent, or combinations thereof. A seal is attached to edges of the top. A control panel is attached to the upper housing. The control panel includes a plurality of input/output interfaces and a display.

The bottomless laser engraver has a base frame, guide rails/strips held within holders which are mounted on the base frame, a slide rail with ends movably attached to the guide rails/strips, light beam guiding units mounted on the base frame, a cutter seat movably mounted on the guide rail by an attachment, and a sensor attached to the cutter seat. Threaded elements are threaded through washers and corners of the base frame. The threaded elements each have a foot at one end and a roller at the opposite end. A belt passes around the rollers. The laser engraver also includes a drive roller and a drive motor.

An engraving method according to the invention carries out steps including providing a bottomless laser engraver, providing a workpiece having a predetermined size, inputting parameter data regarding an engraving operation into the bottomless laser engraver, and moving the bottomless laser engraver to the workpiece. The engraving method also carries out steps including selecting plural reference coordinates on the workpieces, and moving the bottomless laser engraver to each selected reference coordinate on the workpiece. The engraving method also carries out steps including associating reference coordinate with the bottomless laser engraver, moving the bottomless laser engraver near one reference coordinate, activating the laser engraver to effect an engraving operation for an area of the workpiece associated with that particular reference coordinate, recalling cutting seat positioning parameters for engraving a design portion corresponding to the area of the workpiece associated with that particular reference coordinate, and adjusting a height and position of the cutting seat to carry out the corresponding engraving operation for the area of the workpiece associated with that particular reference coordinate. The moving, activating, recalling and adjusting steps are repeated until the etching operation is complete.

While the invention has been described with references to its preferred embodiments, it will be understood by those skilled in the art that various changes may be made and equivalents may be substituted for elements thereof without departing from the true spirit and scope of the invention. In addition, many modifications may be made too adapt a particular situation or material to the teaching of the invention without departing from its essential teachings.

I claim:

1. A bottomless laser engraver comprising:
a lower housing with a bottom defining an area and an aperture defining an area through the bottom substantially the same as the area of the bottom;
an upper housing interconnected to the lower housing; and
a laser assembly mounted in the upper housing, the laser assembly having a laser;
wherein the bottomless laser engraver is configured to etch a design/pattern/lettering in a workpiece having an area that is not restricted by the area defined by the aperture in the bottom of the lower housing.

2. The bottomless laser engraver according to claim 1, wherein said lower housing is made from durable material.

3. The bottomless laser engraver according to claim 2, wherein said durable material is metal, plastic, composites, or combinations thereof.

4. The bottomless laser engraver according to claim 1, further comprising a plurality of handles attached to the lower housing.

5. The bottomless laser engraver according to claim 4, further comprising a plurality of removable wheels interconnected by a mounting that is removably attachable to the plurality of handles.

6. The bottomless laser engraver according to claim 1, further comprising a plurality of adjustable vents mounted in the lower housing.

7. The bottomless laser engraver according to claim 1, further comprising a seal placed on the bottom of the lower housing.

8. The bottomless laser engraver according to claim 1, further comprising a top pivotally attached to the lower housing.

9. The bottomless laser engraver according to claim 8, wherein the top is transparent, translucent, or combinations thereof.

10. The bottomless laser engraver according to claim 8, wherein a seal is attached to edges of the top.

11. The bottomless laser engraver according to claim 8, further comprising a control panel attached to the upper housing.

12. The bottomless laser engraver according to claim 11, wherein said control panel comprises a plurality of input/output interfaces.

13. The bottomless laser engraver according to claim 10, wherein said control panel comprises a display.

14. The bottomless laser engraver according to claim 1, further comprising:
a base frame;
guide rails/strips are held within holders which are mounted on the base frame;
a slide rail with ends movably attached to the guide rails/strips;
light beam guiding units mounted on the base frame;
a cutter seat movably mounted on the guide rail by an attachment; and
a sensor attached to the cutter seat.

15. The bottomless laser engraver according to claim 14, further comprising:
a threaded elements threaded through washers and corners of the base frame, the threaded elements each having a foot at one end and a roller at the opposite end;
a belt passing around the rollers;
a drive roller; and
a drive motor.

16. An engraving method comprising:
providing a bottomless laser engraver;
providing a workpiece having a predetermined size;
inputting parameter data regarding an engraving operation into the bottomless laser engraver; and
moving the bottomless laser engraver to the workpiece.

17. The engraving method according to claim 16, further comprising:
selecting plural reference coordinates on the workpieces; and
moving the bottomless laser engraver to each selected reference coordinate on the workpiece.

18. The engraving method according to claim 17, further comprising associating reference coordinate with the bottomless laser engraver.

19. The engraving method according to claim 18, further comprising:
moving the bottomless laser engraver near one reference coordinate;
activating the laser engraver to effect an engraving operation for an area of the workpiece associated with that particular reference coordinate;
recalling cutting seat positioning parameters for engraving a design portion corresponding to the area of the workpiece associated with that particular reference coordinate; and
adjusting a height and position of the cutting seat to carry out the corresponding engraving operation for the area of the workpiece associated with that particular reference coordinate.

20. The engraving method according to claim 19, further comprising:
repeating the moving, activating, recalling and adjusting steps until the etching operation is complete.
